(19) United States
(12) Patent Application Publication
(10) Pub. No.: US 2010/0077090 A1
(43) Pub. Date: Mar. 25, 2010

(54) Fast switching between multiple user sessions

(76) Inventor: Joseph Chyam Cohen, Burbank, CA (US)

Correspondence Address: Albert R. Ubieta;Torrey Pines Intellectual Property Group, P.C., No. 431, 2658 Del Mar Heights Road, Del Mar, CA, 92014, US

(21) Appl. No.: 12/586,614

(22) Filed: Sep. 23, 2009

Related U.S. Application Data
(60) Provisional application No. 61/099,549, filed on Sep. 23, 2008.

(51) Int. Cl. G06F 15/16; H04L 9/32

(52) U.S. Cl. 709/228; 726/12

(57) ABSTRACT

Methods, apparatus, systems and computer program product for instantiating user sessions in a terminal server environment in such a way as to accomplish fast switching between multiple user sessions while all user sessions are fully isolated from one another. The methods can embody a communication method wherein a user's credentials are used to identify the instances of system resources, for example, applications, that a user is using. This grouping can be referred to as a context, which may be associated with a particular user session. Independent communication mechanisms or pathways with window server for each context can be created and maintained. A bootstrap component can be created in such a manner that a logical barrier between user sessions is initiated and maintained; each instance of a given application thereby will be associated with a specific context. Additional control of information flow between bootstrap processes can be provided via a gateway, which may also manage communication between the components of the operating system and local user input/output agents.

### CROSS-REFERENCE TO RELATED APPLICATIONS

This application claims the benefit of provisional patent application Ser. No. 61/099,549, filed Sep. 23, 2008, which is incorporated by reference.

### FEDERALLY SPONSORED RESEARCH

Not applicable.

### SEQUENCE LISTING OR PROGRAM

Not applicable.

### FIELD OF THE INVENTION

The present invention relates to the field of computer networks. In particular, the present invention relates to methods, apparatus and computer program product for fast switching between multiple user sessions.

### BACKGROUND

For enterprises large and small, consolidation of hardware and software is increasingly vital due to reasons of accessibility, reliability, data security, cost and the administration of applications and the network itself. Managing remote users, their computing experience and their access to networks is similarly crucial. Many different types of institutions have used terminal server applications to provide a computing environment and to address these issues, despite having varied institutional and computing objectives. For instance, educational institutions deploy computer networks to allow teachers, students and staff to connect remotely, thereby allowing increased productivity, easier access to information, rapid communication and, ultimately, enhanced learning opportunities. Government agencies are perhaps more concerned with data security, which is why terminal services always have been essential to their information technology infrastructures. Thin client and network deployments have been mandated in several agencies—this allows all operations to be performed centrally, and secures and monitors information that may have been sent or received. Commercial organizations, as well, benefit from deploying terminal servers so that data transmission can be managed and controlled; for example, by requiring users to access data through smart cards and biometrics, and allowing editing and review of the data only within a secure environment, or by certain identified users. And in the case of organizations of all types there is a growing need for network users to access information via mobile or handheld devices from remote locations.

Centralized computing results in cost savings, ease of administration and enhanced security. Since almost all the processing of an application is done on a central server, companies are not forced to continuously upgrade or replace client or user hardware to keep pace with the systems requirements of modern applications. Maintenance of applications is isolated to the application server and not each individual node, also reducing administrative overhead. Servers are usually located in secure data centers, reducing the risk of physical theft. Centralized malware and audit processes also facilitate enhanced security. In addition, replacing workstations with thin clients can reduce energy consumption, environmental costs, support cost, and hardware costs.

Despite these advantages, contemporary network protocols often suffer from drawbacks in that they are not optimized to provide a graphical interface in a multi-user environment. While many systems have a facility with multiple-user communications in a text-based communication sense, for example via TTY in Unix-like systems, graphical input and output in a multi-user networked environment remains cumbersome. For example, in the Mac OS X operating environment provided by Apple Inc. of Cupertino, Calif., the window server component is not optimized for graphical interaction with multiple users. For instance, the OS X window server communicates over a graphical socket, graphical Mach port or similar, depending on the version. Despite the availability of these protocols, a need exists for improved network communications allowing better security, better resource management and faster, more robust operation.

### SUMMARY

The disclosed embodiments relate to methods, apparatus, systems and computer program product for instantiating user sessions in a terminal server environment in such a way as to accomplish fast switching between multiple user sessions. In accordance with a preferred embodiment, the disclosed methods, apparatus, systems and computer program product provide functionality to multiple users whose demands on the operating system may differ in scope, extent or time. Thus, among the advantages disclosed herein, one or more aspects are to provide a faster and more secure computing environment. Other advantages relate to the ability to keep a user session running in the background of an operating system while streamlining users' interfaces with the computing environment. These and other advantages of the many aspects of the disclosed embodiments will become apparent from a review of the following description and corresponding figures.

Via certain embodiments disclosed herein, users can simply log into a server as if connected directly to the server's console, work with a full-featured desktop and run applications while all user sessions are fully isolated from one another. Embodiments disclosed herein facilitate sharing the resources of a common server, providing the advantages of simplified installation, configuration and maintenance of programs; management of user policies and profiles; central administration of user environments and security; simultaneous resource sharing and usage; faster processing and greater security.

In certain embodiments disclosed herein, the methods, apparatus, systems and computer program product embody a communication method wherein a user's credentials are used to identify the instances of system resources, for example, applications, that a user is using. In certain embodiments, this grouping is referred to as a context, which may be associated with a particular user session. In certain embodiments, this allows independent communication mechanisms or pathways with window server for each context. As a non-limiting example, if separate instances of an application, such as Finder, have been launched in multiple user contexts or sessions, each instance of the application will communicate with window server using a distinct set of communication mechanisms or pathways, thereby isolating user sessions from one another, but maintaining each user's applications within a particular session. This may be accomplished, for example, by creating a bootstrap component in such a manner that a logical barrier between user sessions is initiated and maintained; each instance of a given application is thereby associated with a specific context. According to one embodiment, each specific context is associated with only a single session, although each session may optionally contain more than one context. According to certain embodiments, additional control of information flow between bootstrap processes is provided via a gateway. A gateway may also manage communication between the components of the operating system and local user input/output agents. Creating separately-identified and identifiable bootstrap processes, sessions and/or contexts provides mechanisms allowing allow rapid resource switching or optimization between users and across a network.

### DRAWINGS

The accompanying drawings, which are incorporated in and constitute a part of this specification, illustrate embodiments of the invention and together with the description, serve to explain the principles of the invention.

FIG. 1 graphically depicts a typical operating system with a plurality of elements relating to a user session.

FIGS. 2A-B graphically depict exemplary operating systems configured to host multiple user sessions, optionally including a user gateway.

FIG. 3 graphically depicts an exemplary operating system configured to host one or more remote user sessions.

FIG. 4 is a flow chart of an exemplary process for instantiating multiple user sessions in an operating system environment.

FIGS. 5A-B graphically depict exemplary operating systems configured to implement fast user switching.

### DETAILED DESCRIPTION

Exemplary embodiments of the present invention are now described in detail, including depiction of the hardware components which serve as the context for the process embodiments.

Embodiments of this disclosure may employ the Remote Desktop Protocol, the X Window System, the Virtual Network Computing system, and/or other known protocols for facilitating network communications. Remote Desktop Protocol (“RDP”) is a multi-channel capable protocol that allows for separate virtual channels for carrying device communication and presentation data from a server, as well as encrypted client mouse and keyboard data. RDP provides an extensible base and supports up to 64,000 separate channels for data transmission and provisions for multipoint transmission. Clients exist for most versions of Windows and other operating systems such as Linux, FreeBSD, Solaris and Mac OS X. The X Window System (commonly X11 or X) is a windowing system which implements the X display protocol and provides windowing on bitmap displays. It provides a toolkit and protocol with which to build graphical user interfaces (GUIs) on most Unix-like operating systems and OpenVMS, and has been ported to many other contemporary operating systems. X was specifically designed to be used over network connections rather than on an integral or attached display device. X features network transparency: the machine where an application program (the client application) runs can differ from the user's local machine (the display server). The client and server may run on the same machine or on different ones, possibly with different architectures and operating systems. A client and server can even communicate securely over the Internet by tunneling the connection over an encrypted network session. Virtual Network Computing (VNC) is a graphical desktop sharing system which uses the RFB protocol to remotely control another computer. The VNC protocol (RFB) is very simple, based on one graphic primitive from server to client (“Put a rectangle of pixel data at the specified X,Y position”) and event messages from client to server. It transmits the keyboard and mouse events from one computer to another, relaying the graphical screen updates back in the other direction, over a network. VNC is platform-independent—a VNC viewer on any operating system usually connects to a VNC server on any other operating system. There are clients and servers for almost all GUI operating systems and for Java. Multiple clients may connect to a VNC server at the same time. Popular uses for this technology include remote technical support and accessing files on one's work computer from one's home computer, or vice versa.

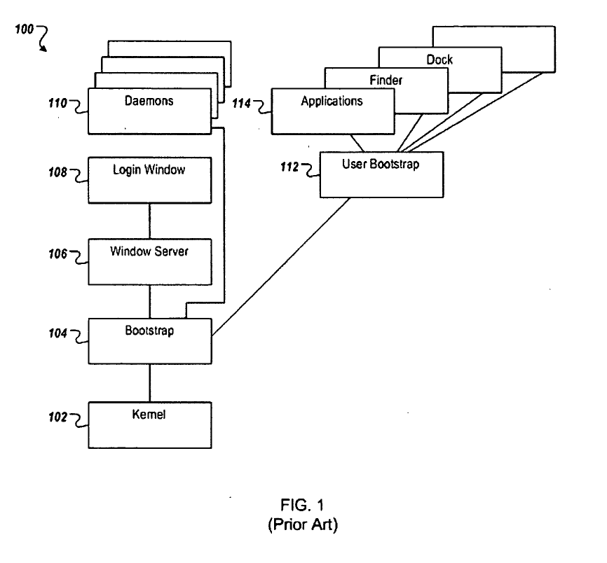

FIG. 1 shows an example operating system 100, which can include a plurality of architectural elements relating to a single user session (or context). For example, the operating system 100 can include a kernel 102, a system bootstrap 104, a window server 106, a login windows 108, and one or more daemons 110. Further, the operating system 100 can include a user bootstrap 112 associated with the system bootstrap 104, and one or more applications 114. The operating system 100 can be hosted in any suitable computing architecture, such as a desktop computer, a laptop computer, a palm top computer, a server, a mobile communications device, and an embedded computing system. For example, the operating system 100 can be a Mac OS provided by Apple Inc. of Cupertino, Calif., a Windows operating system provided by Microsoft Corporation of Redmond, Wash., or a Linux operating system. Other configurations of the operating system 100 are possible.

The kernel 102 can be one or more objects, modules, or processes that provide, at least in part, the core functionality of the operating system 100. Further, the kernel 102 can serve as an interface between the operating system 100 and the hardware on which the operating system 100 is hosted. For example, the kernel 102 can provide functions such as low level scheduling, central processing unit (CPU) context switching, and interrupt handling. Examples of the kernel 102 can include, but are not limited to, the X is Not Unix (XNU) kernel provided by Apple Inc., the Linux kernel released under the GNU General Public License, and the Windows NT kernel provided by Microsoft Corporation.

The system bootstrap 104 can be one or more objects, modules, or processes that can load operating instructions in the operating system 100 and that can manage one or more of the applications 114 hosted and executed in the operating system 100 context. Examples of the system bootstrap 104 can include, but are not limited to, launchd associated with the Mac operating system and Init associated with the Linux operating system. The window server 106 can be one or more objects, modules, or processes that can be configured to control the placement and appearance of graphical user interface elements, such as windows, in a display associated with the operating system 100. Examples of the window server 106 include, but are not limited to, the Quartz window server associated with the Mac OS and the X window server.

The login window 108 can be one or more objects, modules, processes, windows, or user interface screens that can be used to authenticate a user and/or to initialize a session in the operating system 100. The login window 108 exists in the operating system context, outside of a user session, and can receive information identifying which user is seeking to login. Examples of the login window 108 include, but are not limited to, a GUI element or text interface including one or more prompts for a user name and/or a password, and/or a GUI element directing a user to enter authenticating biometric input, such as a fingerprint. In some implementations, the login window 108 also can be used to validate that the user is authorized to access one or more operating system 100 resources, such as a terminal server environment. Additionally, information collected via the login window 108 can be supplied to a login window included in the corresponding user session. For example, username and password information can be provided to a user session login window, such that the information need not be entered multiple times.

The one or more daemons 110 can be objects, modules, processes, or programs that can execute in the operating system 100 context. One or more of the daemons 110 can run independently of user control and can run independent of any user session associated with the operating system 100. Further, one or more of the daemons 110 can perform functions such as error logging, hardware monitoring, and/or power management.

The user bootstrap 112 can be one or more objects, modules, or processes configured to load operating instructions in the operating system 100 and to manage one or more running applications. Examples of the user bootstrap 112 can include, but are not limited to, launchd associated with the Mac operating system and Init associated with the Linux operating system.

The one or more applications 114 can be one or more objects, modules, processes, or programs that can run in accordance with a user's control. The one or more applications 114 can be initiated and/or managed by the user bootstrap 112. The applications 114 can include, but are not limited to, file explorers such as the Finder application associated with the Mac OS or Nautilus provided by the GNOME Project, window organization programs, web browsers, and multimedia applications.

Messaging between components in the operating system 100 can be facilitated by the system bootstrap 104 and the user bootstrap 112. Additionally, the applications 114 can pass messages to one another as permitted by the operating system 100. In some implementations, the applications 114 can communicate directly with the user bootstrap 112. Further, communications between an application 114 and one or more other applications or the daemons 110 can be routed through the user bootstrap 112. The user bootstrap 112 can be configured to forward messages received from an originating application to one or more of the other applications 114. Similarly, a message sent by a daemon 110 to one of the applications 114 also can be routed through the bootstrap 104.

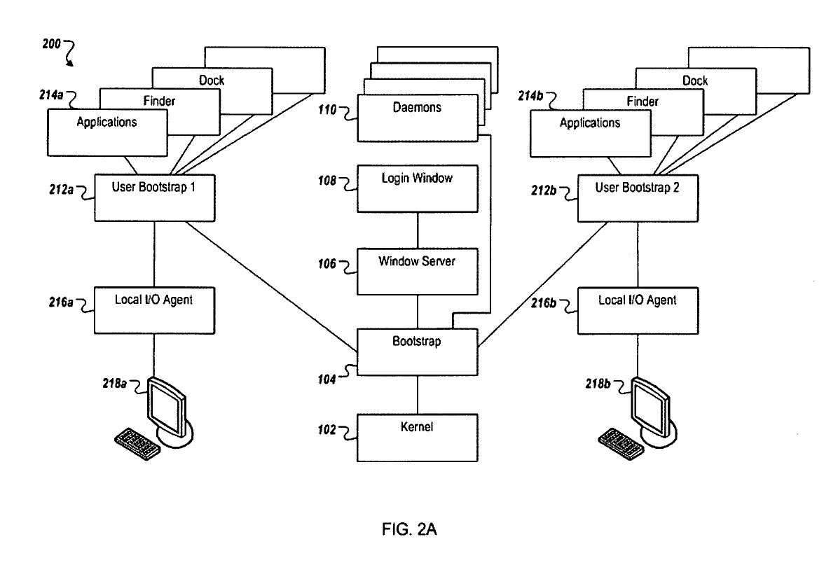

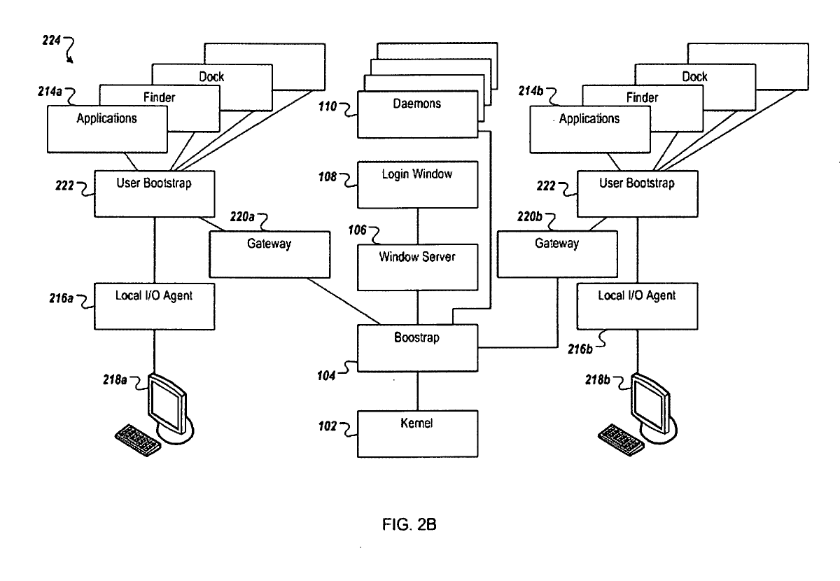

FIG. 2A shows an example operating system 200 configured to host multiple user sessions (or contexts). Each user session can be thought of as an environment in which the user can interact with the operating system and utilize one or more available functions. In some implementations, a user session can be managed such that it is separate from each of the other user sessions hosted by the operating system. Thus, operations can be performed in one user session without affecting the other user sessions. It will be appreciated that some operations performed in a user session can affect the availability of system resources, such as processor and/or memory availability, for one or more other user sessions. In another example, a user session can be given special privileges to monitor or interact with one or more other user sessions hosted by the operating system, such as for maintenance or security purposes.

In some implementations, a user session can have one or more associated applications, such as applications 214a or 214b. The applications 214a and 214b can include, but are not limited to, file explorers, window organization programs, web browsers, and multimedia applications. A user session also can include a user bootstrap, such as user bootstrap 212a and 212b, a local input/output (I/O) agent, such as I/O agent 216a and 216b, and/or a local I/O device, such as I/O devices 218a and 218b. Other configurations of the operating system 200 and/or one or more associated user sessions also are possible.

A user session can include a user bootstrap, such as the user bootstrap 212a or 212b, that can be configured to control communications between a plurality of applications associated with the user session. The first user bootstrap 212a controls communications with and between the first user applications 214a. Further, the first user bootstrap 212a prevents communication between one or more of the first user applications 214a with one or more of the second user applications 214b. Thus, the first user session can be maintained separate from all other user sessions hosted by the operating system, such as the second user session. Further, each of the user bootstraps, including the user bootstraps 212a and 212b, can be a forked copy of the system bootstrap 104.

The local I/O agents 216a and 216b can pass input and output data from the corresponding user bootstraps 212a and 212b to the local I/O devices 218a and 218b, respectively. The first user bootstrap 212a can control communication with the local I/O agent 216a and can prevent any communication between the local I/O agent 216a and any of the second user applications 214b. Similarly, the second user bootstrap 212b can prevent communication between the local I/O agent 218b and any of the first user applications 214a. A user bootstrap also can be configured to prevent communication between the local I/O agent and any object not associated with the corresponding user session.

In some implementations, more than two user sessions can be instantiated. A user bootstrap, local I/O agent, local I/O device, and one or more applications can be generated for each user session executed in the operating system 100. In some implementations, each of the user sessions can be configured to share the same local I/O devices. Thus, only one user session, the current session, is able to access the local I/O devices at a time. The other user sessions can be prevented from accessing the local I/O devices. When a single local I/O device is shared by all of the user sessions, the user sessions also can be configured to share one local I/O agent. Alternatively, a dedicated local I/O agent can be associated with each user session.

FIG. 2B shows an example operating system 224 configured to host multiple user sessions. A user session can include a user bootstrap, such as user bootstrap 222a or 222b, a gateway, a local I/O agent, and one or more local I/O devices. Further, a user gateway, such as the user gateway 220a or 220b, can be associated with each user session to control communications between the components of the operating system 224, such as the daemons 110, the applications 214a and 214b, and the local I/O agents 216a and 216b, respectively.

Messages, e.g. from an application or from a local I/O agent, that are addressed to an object in a different user context can be halted by the corresponding user gateway. Thus, the user gateway can prevent messages from passing out of the user session. A user gateway, such as the user gateways 220a and 220b, also can be configured to prevent the delivery of a message to an object in the corresponding user session that has been sent by a different user session. Thus, the user gateway also can prevent messages from passing to the user session. As a result, each user session can be maintained separate from any other user sessions executing in the operating system.

However, some messages can be allowed to pass through the gateway, into or out of the associated user session. For example, messages from an application 214a or 214b to one or more of the daemons 110, and messages from one or more of the daemons 110 to an application can be allowed to pass through the gateway. In some implementations, more than two user sessions can be instantiated. Each user session can include a gateway, a local I/O agent, a local I/O device, and one or more applications.

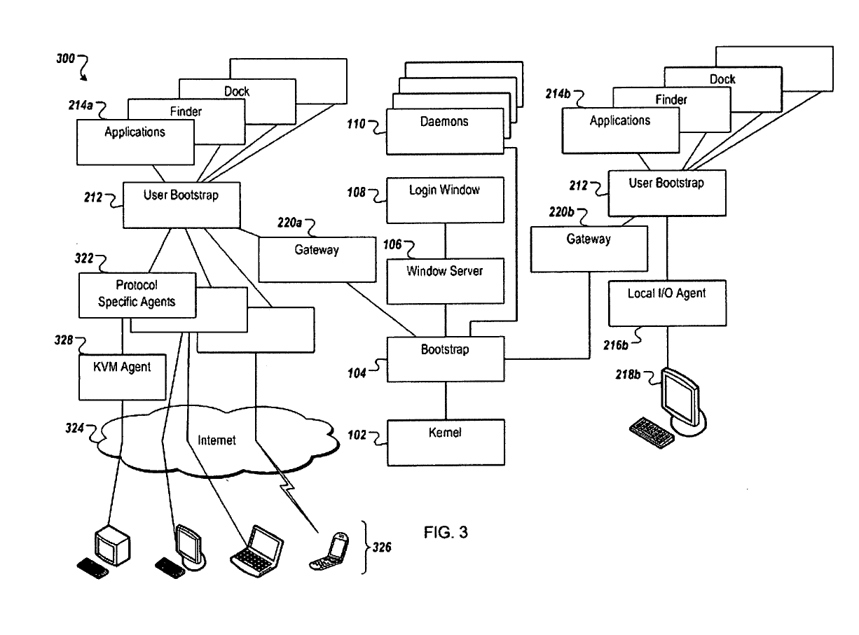

FIG. 3 shows an example operating system 300 configured to support one or more remote user sessions and one or more local user sessions. Each user session can include a gateway, e.g. the gateway 220a or 220b, a user bootstrap, e.g. the user bootstrap 212a or 212b, and one or more applications, e.g. the applications 214a or 214b. Further, a local user session can include a local I/O agent, such as the local I/O agent 216b, and one or more local I/O devices, such as the local I/O devices 218b. A remote user session can include one or more protocol specific agents 322, each protocol specific agent corresponding to one or more I/O protocols, such as the Virtual Network Computer (VNC) protocol, the Remote Desktop Protocol (RDP), or the X11 protocol. Additionally, a remote user session can include a keyboard-video-mouse (KVM) agent 328 and one or more remote clients 326 communicatively connected to the remote user session via a network, such as the Internet 324. Other configurations of the operating system 300, the local user session, and/or the remote user session are possible.

The protocol specific agents 322 can be configured to provide input and output support for a user session with respect to one or more of the remote clients 326. Further, a remote client 326 can utilize a different protocol for input and output than another of the remote clients 326. Thus, a protocol specific agent 322 can be used to generate and transmit messages to a corresponding remote client 326 using the appropriate protocol. In some examples, more than one remote client can be associated with a single protocol specific agent 322. In some implementations, a protocol specific agent 322 can communicate with one or more additional protocol specific agents, such as where no direct translation is possible. Further, the KVM agent 328 can be configured to process and/or translate the I/O messages for a protocol. In some implementations, the KVM agent 328 can logically precede a protocol specific agent 322.

In one example, the cell phone remote client can receive input through its directional buttons and key pad indicating a request to access a webpage. Similarly, the laptop remote client can receive input through its keyboard, mouse, or other input device indicating a request to access the same webpage. The corresponding protocol specific agents 322 can receive the request messages, translate the messages, and transmit the messages to the user bootstrap 212. The request messages passed by the protocol specific agents 322 to the user bootstrap 212 can be similar, since each requests the same resource. However, the requested web page returned to the protocol specific agents 322 can be translated in one way to render the web page on the laptop remote client and in a different way to render the web page on the cell phone remote client 326.

In some implementations, only one of the remote clients 326 is permitted to send messages through the bootstrap 212a to the applications 214a and the daemons 110. The remaining remote clients 326 can be configured to receive output from the user bootstrap 212a, but input from those remote clients 326 to the bootstrap 212a can be blocked. For example, one of the remote clients 326 can act as a presenter and can be permitted to send input to the user session as well as to receive output from the user session. The remaining remote clients 326 can be configured to receive output from the user session, such as to see what actions are being performed in the user session. The remaining remote clients 326, however, will not be permitted to affect the actions being performed in the user session. This is known as shadowing.

In some other implementations, a plurality of the remote clients 326 can interact with the user bootstrap 212a, such as to transmit messages to the applications 214a and/or the daemons 110. In such implementations, each of the remote clients 326 can view actions performed by the other remote clients. For example, a ‘primary user’ that uses the user session in the normal course of their work can receive assistance from an ‘administrative user’ who also can access the user session. In another example, two users working in different cities can be permitted to share a user session, such as to collaborate on a task.

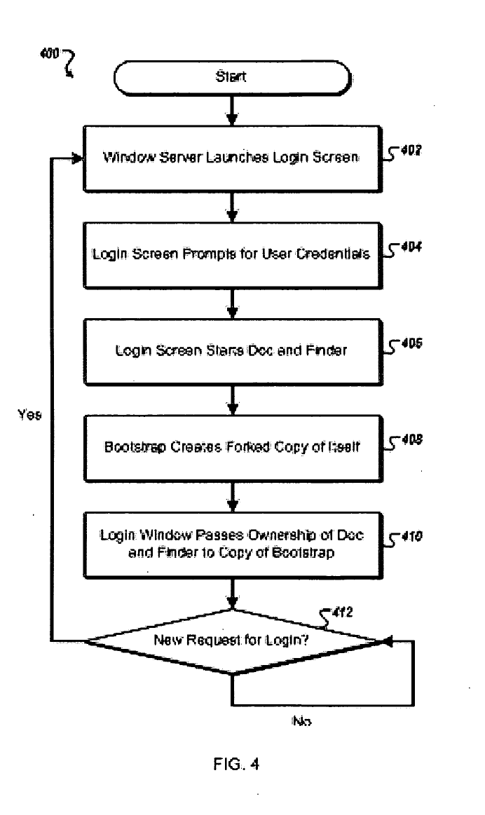

FIG. 4 shows an example process 400 for instantiating multiple user sessions in an operating system environment. A window server can launch a login screen (402). The login screen can be a window or screen presented to the user, such as a prompt requesting information. Further, the login window can prepare the system for a login associated with a new user. A login screen can prompt the user to supply one or more user credentials (404). For example, the user credentials can include identification and verification data, such as a user name and password. Further, the user credentials can include information indicating the type of session to be created, such as the server or system that will be logged into, the type of environment that is to be generated, the connection protocol to be used, and/or the rights desired by the user.

Further, a login screen can be used to launch one or more applications, such as a file management application or web browser (406). In some implementations, one or more applications can be associated with every user session and can be launched automatically during initialization, so that the user does not have to launch them. During session initialization, a system bootstrap also can create forked copies of itself to generate one or more user bootstraps (408). Additionally, using the login screen to launch one or more applications (406) and the generation of one or more user bootstraps (408) can be performed in parallel, independently, or in any sequence.

Further, a login window can pass ownership of the applications, such as the file management application and/or the web browser, to a forked copy of the system bootstrap 410 associated with the user session. In some implementations, one or more applications launched by the login screen are controlled by the login screen. The login screen can then pass control of the applications to the associated bootstrap. Thus, the login screen is not needed by the user session once the user session has been initialized and control of the applications has been passed.

The process 400 can determine whether a new user request to log in has been received (412). If a new user request has not been received, the process 400 waits to receive a new user request. When a user request to log in has been received, the process 400 can be repeated. In some implementations, more than one user session can exist concurrently. It will be appreciated that different configurations of the process 400 are possible for different user sessions, including processes that include more or fewer steps. In some implementations, multiple processes 400 can execute at the same time, allowing multiple users to login at the same time.

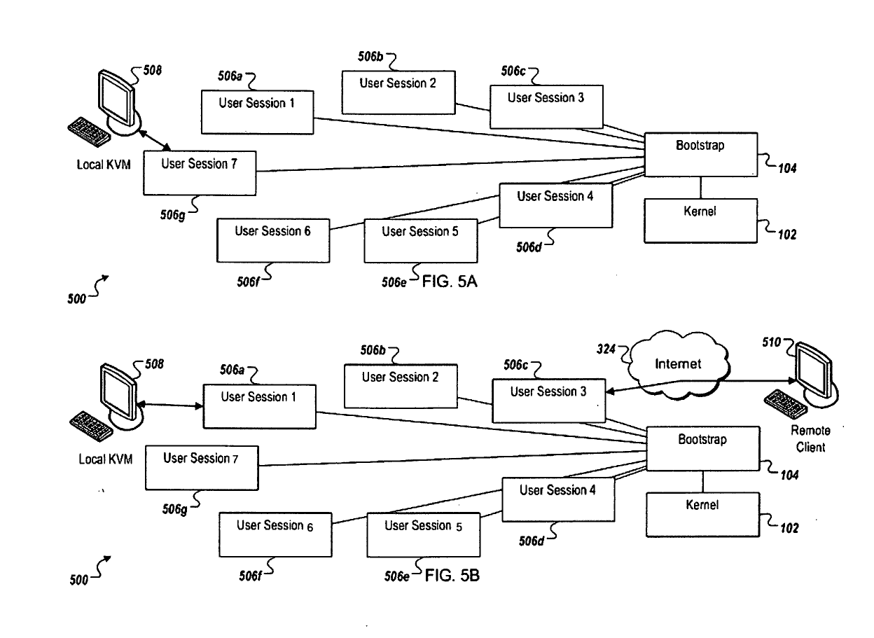

FIG. 5A shows a block diagram of an operating system 500 configured to implement fast user switching. The operating system 500 can simultaneously host multiple user sessions, such as user sessions 506a-g. In some implementations, local input and output devices 508 can be associated with a current user, such as the user session 7 506g. Other user sessions 506a-506f cannot receive input or transmit output while user session 7 506g is the current session. Thus, the user sessions 506a-f are still active, but are running in the background of the operating system 500.

For example, the operating system 500 can provide functionality to many users who only need to use the operating system 500 for short periods of time. The load on the operating system is distributed if the periods of time required are spread out through the day. Fast user switching allows the users to keep a session running in the background of the operating system 500. Thus, the user does not need to spend the time to log in and log out every time they need to perform a task.

Fast user switching further can be used to associate the I/O devices 508 with the current user session 506, as required. In some implementations, changing the association between a user session and the I/O devices 508 can be accomplished by a command received in the user interface of the current user session. For example, the login name of another user can be selected from a list of all running user sessions 506. In another example, a login screen can require the login name and password of another user session 506.

FIG. 5B shows a block diagram of the operating system 500 configured to implement fast user switching. The local I/O devices 508 can be associated with a new current user session 506a. For example, a different user can require access to their user session, so the user can select their username from an on screen drop-down menu.

In some implementations, a remote user 510 can connect via a network, e.g. the Internet 324, to the operating system 500 and can become associated with the user session 506c. The remote user 510 can be given full input and output control over the user session 506c. In some implementations, a remote user 510 also can create a new user session instead of becoming associated with one of the existing user sessions 506.

The embodiments described above are given as illustrative examples only. It will be readily appreciated by those skilled in the art that many deviations may be made from the specific embodiments; accordingly, the scope of the invention is to be determined by the claims below rather than being limited to the specifically described embodiments above. In addition, the flowcharts found in the figures are provided to instruct a programmer of ordinary skill to write and debug the disclosed embodiments without undue effort; the logic flow may include other steps and the system other components. The invention is not limited to a particular expression of source or object code. Accordingly, other implementations are within the scope of the claims.

What is claimed:

1. A method for instantiating a user session in a terminal server environment, the method comprising:
receiving, by a host device, a request from a first user to establish a user session;
authenticating one or more credentials associated with the first user;
initializing the first user session such that it is separate from an operating system context of the host device, wherein the first user session is isolated from one or more other user sessions executing on the host device;
generating a separate user bootstrap corresponding to the first user session; and
initializing an input/output agent associated with the first user session.

2. The method of claim 1 wherein the user bootstrap is a forked copy of the system bootstrap.

3. The method of claim 1 wherein the separate user bootstrap is configured to prevent communication between a local input/output agent and any object not associated with the corresponding first user session.

4. The method of claim 1 further comprising a associating a user gateway with a first user session.

5. The method of claim 4 wherein the user gateway controls communications between the components of the operating system and local user input/output agents.

6. The method of claim 1 further comprising configuring one or more protocol specific agents to provide input and output support for a remote client.

7. The method of claim 1 further comprising generating a login screen wherein the login screen automatically launches one or more applications.

8. The method of claim 7 wherein the login screen passes ownership of said one or more applications to the separate user bootstrap corresponding to the first user session.

9. The method of claim 1 wherein the input/output agent associated with the first user session is configured to prevent one or more other user sessions from receiving input or transmitting output while the first user session is the active session in the operating system context.

10. A tangible computer-readable storage media comprising stored instructions that, upon execution by a programmable processor, are operable to cause the programmable processor to perform the method of claim 1.

11. A computer network system comprising:
a network host server comprising one or more processing elements, wherein the server is in communication with multiple remote devices;
wherein the one or more processing elements are programmed or adapted to perform the steps comprising:
i. receiving, from a remote user via a remote device, a request to establish a user session;
ii. authenticating one or more credentials associated with the user;
iii. initializing the user session such that it is separate from an operating system context of the server processing element, wherein the user session is isolated from one or more other user sessions executing on the server processing element;
iv. generating a separate user bootstrap corresponding to the user session; and
v. initializing an input/output agent associated with the user session.

12. The system of claim 11 wherein the separate user bootstrap is a forked copy of the system bootstrap.

13. The system of claim 11 wherein the separate user bootstrap is configured to prevent communication between a local input/output agent and any object not associated with the corresponding first user session.

14. The system of claim 11 further comprising one or more processing elements programmed or adapted to perform the step of associating a user gateway with a first user session.

15. The system of claim 14 wherein the user gateway controls communications between the components of the operating system and local user input/output agents.

16. The system of claim 11 further comprising one or more processing elements programmed or adapted to perform the step of configuring one or more protocol specific agents to provide input and output support for a remote client.

17. The system of claim 11 further comprising one or more processing elements programmed or adapted to perform the step of generating a login screen wherein the login screen automatically launches one or more applications.

18. The system of claim 17, wherein the login screen passes ownership of said one or more applications to the separate user bootstrap corresponding to the first user session.

19. The system of claim 11 wherein the input/output agent associated with the first user session is configured to prevent one or more other user sessions from receiving input or transmitting output while the first user session is the active session in the operating system context.
